(19) United States
(12) Patent Application Publication
(10) Pub. No.: US 2025/0331040 A1
(43) Pub. Date: Oct. 23, 2025

(54) MITIGATION OF ACCESS POINT SCALE CONSTRAINTS FOR IN-DEVICE COEXISTENCE OPERATION

(71) Applicant: Cisco Technology, Inc., San Jose, CA (US)

(72) Inventors: Brian D. HART, Sunnyvale, CA (US); Binita GUPTA, San Diego, CA (US)

(21) Appl. No.: 19/182,438

(22) Filed: Apr. 17, 2025

Related U.S. Application Data
(60) Provisional application No. 63/636,582, filed on Apr. 19, 2024.

(51) Int. Cl. H04W 76/14; H04W 52/02

(52) U.S. Cl. CPC H04W 76/14; H04W 52/0258

(57) ABSTRACT

The present disclosure provides techniques for in-device coexistence (IDC) management. A first network device transmits an announcement of one or more in-device coexistence (IDC) handling constraints to a second network device. The first network device receives an IDC unavailability report indicating a request for IDC service from the second network device, where the request comprises one or more unavailability windows due to IDC. The first network device transmits an IDC unavailability response to the second network device. The first network device communicates with the second network device in accordance with the IDC service response.

### CROSS-REFERENCE TO RELATED APPLICATIONS

This application claims benefit of co-pending U.S. provisional patent application Ser. No. 63/636,582 filed Apr. 19, 2024. The aforementioned related patent application is herein incorporated by reference in its entirety.

### TECHNICAL FIELD

Embodiments presented in this disclosure generally relate to wireless communication. More specifically, embodiments disclosed herein relate to access points (APs) signaling in-device coexistence (IDC) handling constraints.

### BACKGROUND

Modern wireless client devices, such as smartphones, laptops, and Internet-of-Things (IoT) devices integrate multiple communication technologies within a single device. The technologies may include Bluetooth (BT), Wi-Fi for intranet/Internet connectivity, off-channel Wi-Fi for P2P communications including docking, and Ultra-Wideband (UWB). These communication modules often share common hardware resources without sufficient PHY isolation (e.g., through filtering) or isolated medium access control (MAC) designs. As a result, when multiple radios operate concurrently within the same device, in-device coexistence (IDC) issues may arise, leading to interference and resource contention among the different wireless technologies. To mitigate these issues, coordination mechanisms are needed to maintain efficient radio coexistence and improve overall wireless performance in multi-link or multi-radio devices.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 depicts an example device with Bluetooth (BT), Ultra-Wideband (UWB), and Wi-Fi coexistence, according to some embodiments of the present disclosure.

FIG. 2 depicts an example STA reporting one or more IDC unavailability windows to a connected AP or peer STA, followed by subsequent updates to the unavailability window, according to some embodiments of the present disclosure.

FIG. 3 depicts an example IDC capability announcement, indicating one or more IDC handling constraints, according to some embodiments of the present disclosure.

FIG. 4 depicts an example IDC unavailability response indicating success, rejection, or modification of requested unavailability windows, according to some embodiments of the present disclosure.

FIG. 5 depicts an example IDC unavailability response with alternative AP recommendations, according to some embodiments of the present disclosure.

FIG. 6 depicts an example sequence of interactions between a STA and an AP or peer STA for IDC capability announcement and unavailability report handing, according to some embodiments of the present disclosure.

FIG. 7 depicts an example IDC policy announcement, indicating the IDC management device's policies related to unavailability reporting via a PM mode change, according to some embodiments of the present disclosure.

FIG. 8 depicts an example sequence of interactions between a STA and an AP or peer STA for IDC unavailability reporting via a PM mode change, according to some embodiments of the present disclosure.

FIG. 9 depicts an example method 900 for an AP or peer STA broadcasting its IDC handling capabilities and evaluating and responding to an IDC unavailability report from an associated STA, according to some embodiments of the present disclosure.

FIG. 10 depicts an example method for an AP or peer STA handling IDC unavailability reports with PM mode change, according to some embodiments of the present disclosure.

FIG. 11 is a flow diagram depicting an example method for IDC constraint announcement and unavailability request processing, according to some embodiments of the present disclosure.

FIG. 12 depicts an example network device configured to perform various aspects of the present disclosure, according to some aspects of the present disclosure.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

One embodiment presented in this disclosure provides a method, including transmitting, by a first network device to a second network device, an announcement of one or more in-device coexistence (IDC) handling constraints, receiving, by the first network device from the second network device, an IDC unavailability report indicating a request for IDC service, where the request comprises one or more unavailability windows due to IDC, transmitting, by the first network device to the second network device, an IDC service response, communicating, by the first network device with the second network device in accordance with the IDC service response.

Other embodiments in this disclosure provide one or more non-transitory computer-readable media containing, in any combination, computer program code that, when executed by operation of a computer system, performs operations in accordance with one or more of the above methods, as well as a system of a network device comprising one or more computer processors, and one or more memories collectively containing one or more programs, which, when executed by the one or more computer processors, perform operations in accordance with one or more of the above methods.

### EXAMPLE EMBODIMENTS

Supporting IDC constraints of client devices is an important focus of future wireless standards and amendments, such as the 802.11bn amendment to the 802.11 standard, and likely branded as Wi-Fi 8, or beyond. IDC mechanisms involve client devices reporting one or more unavailability windows (e.g., a single unavailability window, a list of unavailability windows, or a train of periodic unavailability windows) to an access point (AP) or a peer station (STA) (e.g., for peer-to-peer (P2P) communication) when they need or desire to engage in other wireless communications, such as UWB or Bluetooth data transfers. During each of these reported unavailability windows, the AP or peer STA is expected to refrain from transmitting to the requesting device to avoid interference and thence transmission failures. However, client devices may not always report a train of periodic unavailability windows, such as following a fixed pattern and occur at predictable intervals. In some scenarios, client devices may request a list of irregular unavailability windows or one window at a time, or request to start an IDC session when the client device may request a list of irregular unavailability windows or one window at a time. Such irregularity places an enormous burden on the AP or peer STA, particularly when the AP or peer STA lacks a mechanism to reject or negotiate IDC signaling requests. Without such a negotiation mechanism, the AP may be forced to accommodate all unavailability requests, even when network conditions do not permit it; and the AP may not be able to honor this requirement. Additionally, if the AP's scheduling architecture relies on pre-planning for transmission over a period longer than the IDC on/off intervals, dynamically adjusting its operation to accommodate requested unavailability windows may lead to inefficiencies and increased overhead.

Embodiments of the present disclosure provide systems, methods, and apparatuses for signaling IDC handling constraints from the AP (or peer STA) to client devices and for generating IDC-related responses to requests for unavailability windows or an unavailability session. In some embodiments, these constraints may include static data, such as the minimum availability time and the maximum unavailability time supported by the AP, as well as dynamic data, such as the remaining resources available for IDC coordination, including the number of additional P2P target wakeup time (TWT) requests the AP can support, the number of extra unavailability windows the AP can accommodate per each time interval.

In some embodiments, the IDC-related response may be generated by the AP, a peer STA, or another IDC management device and may include a status code indicating approval, rejection, or modification of the requested unavailability windows. In some embodiments, if the AP (or other device) rejects the request, the AP (or other device) may provide a counter-proposal by suggesting a different minimum availability time or maximum unavailability time to better align with network conditions. In some embodiments, the response may include a recommendation for an alternative AP or peer device that may better accommodate the unavailability request.

Embodiments of the present disclosure enable the AP (or peer STA) to announce its IDC capabilities, process IDC unavailability requests, and generate responses to reject or negotiate requested unavailability windows. Upon receiving a requested unavailability window, the AP (or peer STA) may immediately evaluate its feasibility based on real-time network conditions, scheduling constraints, and resource availability. Based on the evaluation, the AP (or peer STA) generates a response to either approve the request, reject it, or propose modifications. The real-time adaptation improves IDC management and enhances wireless performance, particularly when irregular unavailability windows (e.g., windows that do not follow a predictable pattern) are requested.

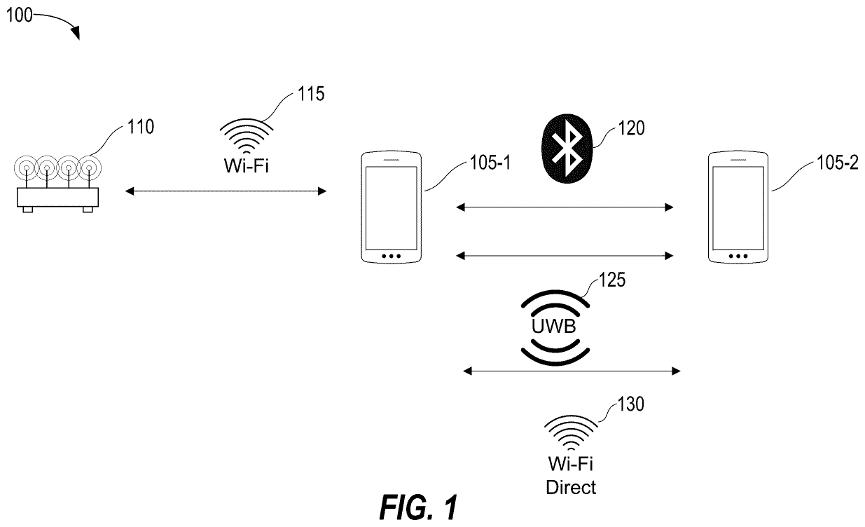

FIG. 1 depicts an example device 105-1 with Bluetooth, UWB, and Wi-Fi coexistence, according to some embodiments of the present disclosure.

As depicted, STA 105-1 connects to AP 110 as a client in a Wi-Fi Basic Service Set (BSS). Through this Wi-Fi connection 115, STA 105-2 gains access to the broader network infrastructure (e.g., Internet). This connection follows Wi-Fi infrastructure mode, where AP 110 manages the communication between STA 105-1 and other devices on the network and coordinates transmission timing and resource allocation.

As depicted, STA 105-1 also maintains direct connections with peer STA 105-2 using Bluetooth 120, Ultra-Wideband (UWB) 125, and Wi-Fi Direct/Wi-Fi Aware 130. The Bluetooth connections 120 between STA 150-1 and STA 105-2 enable low-power, short-range data exchange, such as audio streaming, peripheral device pairing, or file transfers. The UWB connections 125 allow high-precision spatial awareness and data synchronization, which may be used for indoor positioning, secure keyless access, or precisely coordinated audio streams via the two devices 105-1 and 105-2. The Wi-Fi Direct/Wi-Fi Aware 130 facilitates high-speed and medium-range data transfer, such as sharing of large files or streaming high-quality media between devices.

In this figure, STA 105-1 is depicted as a mobile phone, which is provided for conceptual clarity. In some embodiments, STA 105-1 may be any other wireless communication devices, such as laptops, tablets, smartwatches, or any other portable or stationary devices configured with multiple wireless communication technologies.

The depicted wireless technologies, including Wi-Fi for infrastructure connections 115, Bluetooth 120, UWB 125, and Wi-Fi Direct/Wi-Fi Aware 130, are provided as examples for conceptual clarity. In some embodiments, STA 105-1 may support fewer or additional wireless communication interfaces, including Wi-Fi for off-channel docking (used for wireless display mirroring, data transfer, or peripheral connections to a docking station) or Near Field Communication (NFC) (for short-range authentication and data exchange). In some embodiments, STA 105-1 may utilize an MLO setup, where the device 105-1 maintains simultaneous connections to AP 110 over multiple frequency bands. For example, the STA 105-1 may establish three concurrent links with AP 110, including one link on the 2.4 GHz band (for longer range and lower power consumption), one link on the 5 GHz band (for higher throughput and reduced interference), and one link on 6 GHz band (for ultra-fast and low-latency communication). In some embodiments, the STA 4105-1 may maintain one link (e.g., 2.4 GHz) to AP 110 and another link (e.g., 5 GHz) to STA 105-2 for peer-to-peer (P2P) communication.

As depicted, since STA 105-1 integrates multiple wireless technologies within a shared hardware environment, the device 105-1 may use in-device coexistence (IDC) management to efficiently allocate resources between Wi-Fi 115, Bluetooth 120, UWB 125, and Wi-Fi Direct/Wi-Fi Aware 130. Without proper coordination, simultaneous transmissions across these radios or reception-while transmitting may cause interference and degrade the overall network performance. To mitigate interference, STA 105-1 may need assistance from AP 110 and STA 105-2 in managing wireless coexistence and reducing conflicts between different communication protocols.

To facilitate IDC mitigation, STA 105-1 may report unavailability windows to AP 110 and/or STA 105-2, informing them of periods during which the device 105-1 will be unavailable due to the need to allocate resources to another technology (e.g., pausing Wi-Fi communication to prioritize bursts of a Bluetooth audio stream or UWB positioning session). However, although the unavailability windows may be predicted in advance, actual conditions may change, requiring STA 105-2 to send updates to modify the reported windows. Additionally, the requested unavailability windows may not always follow a fixed pattern. A client device 105-1 may request irregular or dynamically changing unavailability windows. For example, Bluetooth activity may require intermittent but unpredictable resource allocations, while UWB transmissions may trigger periodic but non-uniform interruptions in Wi-Fi connectivity. These irregular unavailability requests and too frequent updates create an enormous burden on the AP 110 or peer STA 105-2, especially when managing multiple client devices that each require adaptive scheduling and dynamic coordination to balance network efficiency and coexistence.

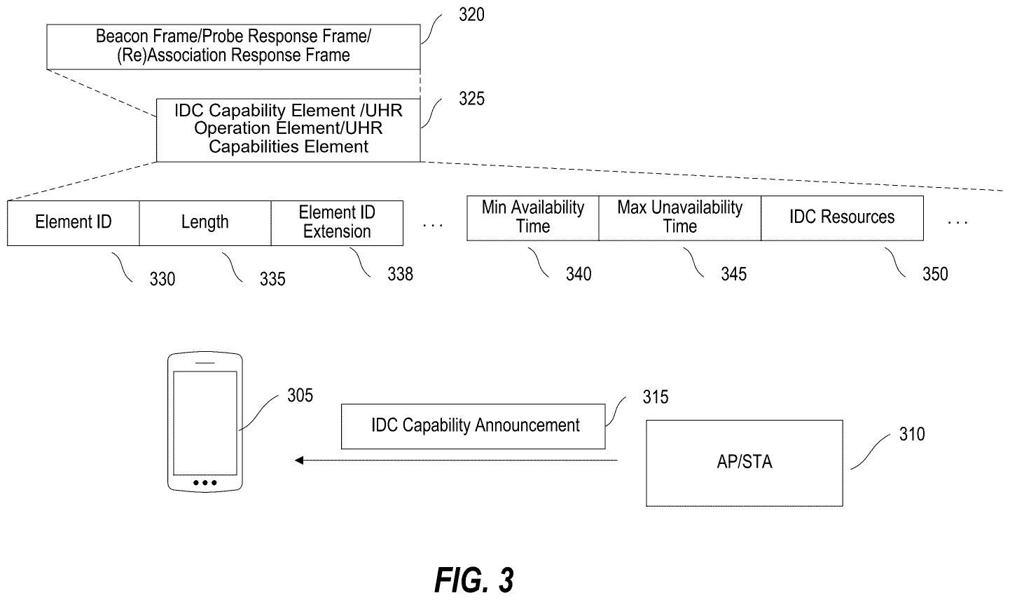

The challenge becomes even more significant when the AP 110 (or peer STA 105-2) lacks a mechanism to reject or negotiate the unavailability windows either as individual windows, or a list of windows, or a train of periodic windows or as a IDC session that enables sending of messages for individual windows or a list of windows with STA 105-1. If the AP 110 (or peer STA 105-2) is forced to accept all IDC unavailability requests without the ability to evaluate feasibility, propose modifications, or reject requests that exceed network constraints, it may lead to suboptimal scheduling, failure to honor requests, excessive transmission delays, or reduce overall network performance. To address this challenge, embodiments of the present disclosure provide a mechanism that allows the AP 110 or peer STA 105-2 to assess unavailability window requests in real time, determine whether these requests can accommodate, and generate responses accordingly-either by approving, rejecting, or negotiating modifications to the requested window. More details are discussed below with references to FIGS. 3-8.

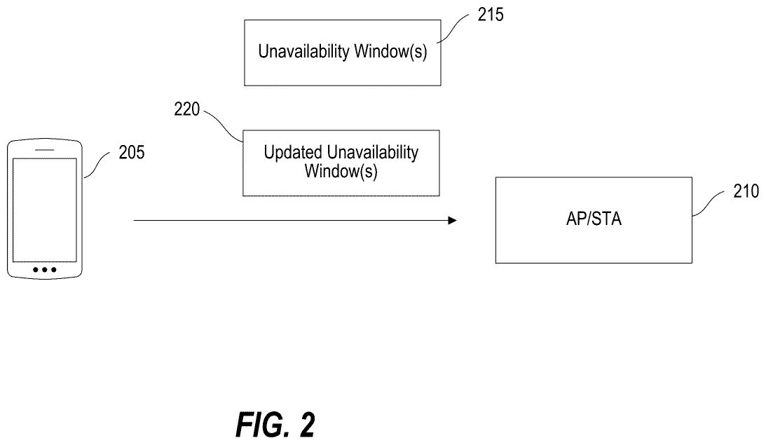

FIG. 2 depicts an example STA 205 reporting one or more IDC unavailability window 215 to a connected AP or peer STA 210, followed by subsequent updates 220 to the unavailability window 215, according to some embodiments of the present disclosure.

As depicted, STA 205 (which may correspond to STA 105-1 of FIG. 1) reports one or more unavailability windows 215 to AP 210 (which may correspond to AP 110 of FIG. 1). The report may indicate the time periods during which STA 205 expects to be unavailable for Wi-Fi communication, such as when it needs to allocate hardware or spectrum to another wireless technology (e.g., Bluetooth or UWB communication). For each unavailability period, the timing may be specified in various forms, as either a start time (e.g., T1) and an end time (e.g., T2) or a start time (e.g., T1) with a duration (e.g., 0.5 ms). STA 205 may use a management frame to report this unavailability window to AP 210, such as a (Re) Association Request frame, an Operating Mode Notification (OMN) frame, a Channel Usage Request frame, or a specific frame designed for IDC mitigation reporting. In some embodiments, the device receiving the unavailability window may be a peer STA (which corresponds to STA 105-2 of FIG. 1) that maintains a direct connection with STA 205, such as in a Wi-Fi Direct/Wi-Fi Aware, Bluetooth, or UWB communication setup.

In some embodiments of the present disclosure, “(Re) Association” and similar terms refers to both “association” as well as “re-association.” For example, a “(re) association response frame” may refer to an “association response frame,” a “re-association response frame,” or both. Similarly, in some aspects, “association” may refer to an initial association and/or a re-association.

In one embodiment, the report 215 may include a single unavailability window, such as defined by a start time (e.g., T1) and an end time (e.g., T2), or alternatively by a start time and a duration (e.g., T1 and 0.5 ms). In another embodiment, the report may include a list of multiple unavailability windows in a single message. For example, the report may specify: Len=2, T1, 0.5 ms; T2, 1 ms, where each window is defined by a respective start time and duration. This allows the STA to efficiently communicate multiple, independent windows in one transaction. In another embodiment, the report 215 may include a train of recurring unavailability windows, which includes a start time, a period (the time between the start of each successive window), and a duration for each window. The train may optionally include an end time or a window count, after which the schedule terminates. With the report, the AP or peer STA 210 may apply consistent coordination rules over a repeating schedule without requiring individual reports for each unavailability window. In another embodiment, the STA 205 may initiate a Delayed Update Operation (DUO) session, where a message 215 first signals the start of an IDC session, followed by the STA 205 reporting its unavailability using any of the formats discussed above (e.g., a single window, a list or a train of unavailability windows). The session remains active until a future message signals the end of the DUO session.

The reported unavailability windows are predictive in nature, estimated by STA 205 based on its anticipated needs for non-Wi-Fi communication. The prediction may be based on various factors, including but not limited to the expected Bluetooth/UWB activities, power management constraints, or scheduled tasks requiring a different radio interface. When any of these factors change, the initially reported unavailability window may no longer be accurate and require an update. As depicted, STA 205 transmits an updated report 220 to modify the originally reported window 215. These update messages may modify any previously reported unavailability configuration including the parameters of a single window, entries in a list, values defining a window train, or details within an active DUO session. The update may cancel, shorten, extend, or fully replace the previous report.

However, when updates 220 are sent too frequently (e.g., exceeding a defined limit), such as in embodiments where STA 205 repeatedly changes its reported unavailability windows within short time intervals, this behavior can impose a significant burden on AP (or peer STA) 210. The AP 210 may need to process, validate, and adjust its scheduling and resource allocation to accommodate the frequent modifications. Such frequent adaptation may lead to increased control overhead, inefficient scheduling, and potential conflicts with pre-planned resource allocation. In embodiments involving P2P communication, a peer STA may also struggle to adjust its resource scheduling if the transmitting STA 205 continues to modify its availability status.

To facilitate efficient IDC mitigation, AP/peer STA 210 may implement a mechanism that allows them to reject or negotiate unavailability windows, rather than automatically accepting all requests. Further details regarding this mechanism and how it enables APs and STAs to manage IDC constraints are discussed below with references to FIGS. 3-8.

FIG. 3 depicts an example IDC capability announcement 315, indicating one or more IDC handling constraints, according to some embodiments of the present disclosure.

As depicted, AP (or a peer STA) 310 (which may correspond to AP 110 of FIG. 1, STA 105-2 of FIG. 1, or AP/STA 210 of FIG. 2) transmits an IDC capability announcement to STA 305 (which may correspond to STA 105-1 of FIG. 1 or STA 205 of FIG. 2). The announcement 315 provides information regarding the AP/STA's 310 IDC handling constraints. The announcement 315 may be sent proactively, such as in Beacon frames, and/or in response to a request from STA 205, such as in a Probe Response frame or a (Re) Association Response frame.

The IDC capability announcement 315 may include static constraints and dynamic indicators. The static constraints may include predefined constraints, such as the minimum availability time that STA 205 is required to maintain between unavailability windows, the maximum unavailability time that STA 205 is allowed to request, or the maximum rate of unavailability windows messages that an associated STA is permitted to send to its AP. The defined static parameters are used to prevent STAs from requesting unavailability windows if their recent unavailability requests are too frequent and/or for excessive durations. By setting the minimum availability time, the AP 310 ensures that STAs 305 maintain sufficient active communication periods to receive network updates, acknowledgements, or buffered traffic without overly burdening the AP's scheduler or expecting infeasible AP processing or would requiring an undue priority inversion. Similarly, by defining the maximum unavailability time, the AP 310 may prevent STAs 305 from remaining unavailable for excessive durations, so that network resources are used efficiently and fairly distributed among multiple devices. Finally, by limiting the maximum rate of unavailability windows messages that an associated STA is permitted to send to its AP, the AP can limit the processing it is required to undertake, and also incentivize STAs to report their most important unavailability windows only after their start and duration are known with high likelihood.

The dynamic indicators may provide real-time resource availability information, such as the number of extra P2P TWT requests the AP 310 can support, the number of extra unavailability windows per second the AP 310 can accommodate, and/or the number of extra availability windows per second the AP 310 can support. These may be signaled as per BSS parameters and/or per STA parameters.

These capability details (also referred to in some embodiments as IDC handling constraints) may be included within a new element, such as IDC Capability element 325, or may be sent in an element with a broader purpose, such as an UHR Capabilities element, an UHR Operation element, a Coexistence (Coex) element or an IDC element, and may be transmitted in Beacon frames, Probe Response frames, (Re) Association Response frames, and/or any other suitable management or control frames used for IDC signaling. In some embodiments, the static constraints and dynamic indicators may be included in separate elements, such as the static data being included within an IDC Static element and the dynamic indicators being included within an IDC Dynamic element.

In some embodiments, the static and/or dynamic data may be broadcast proactively, such as in Beacon frames, allowing all STAs 305 in the network to be aware of the minimum availability time and maximum unavailability time constraints set by the AP/STA 310 with little effort. In contrast, in some embodiments, the static and/or dynamic indicators (e.g., the number of extra P2P TWT requests, extra unavailability windows per second, or extra availability windows per second) may only be included in Probe Response frames or (Re) Association Response frames, or in other management or control frames, where they are provided in response to a specific request for information or a specific request for IDC service from a STA 305. This distinction may be used to reduce unnecessary overhead in periodic broadcasts. Since static constraints remain relatively constant, broadcasting them in individual response frames (e.g., in Probe Response frames or (Re) Association Response frames) allows STAs to be informed without requiring additional queries. On the other hand, dynamic indicators reflect real-time resource availability, which may fluctuate frequently based on network conditions, STA activities, and ongoing traffic demands. To manage this efficiently, two approaches may be used: (a) broadcasting dynamic data (e.g., in Beacon frames) allows the AP/STA 310 to provide up-to-date information to STAs 305 with minimal STA effort and/or (b) providing dynamic data only in response to STA requests (e.g., via Probe Response frames or (Re) Association Response frames, or another management or control frame requesting some form of IDC service) enables the AP/STA 310 to provide up-to-date information to STAs 305 that actively need it, without overloading the Beacon frames (which are transmitted at regular intervals to all STAs).

As depicted, the IDC Capability element 325 includes the following fields: an Element ID field 330, a Length field 335, an Element ID Extension field 338 (included if Element ID=255), a Min Availability Time field 340, a Max Unavailability Time field 345, an IDC Resources field 350. One or more of the fields after the Length field 335 and IDS Resources field 350 may be present.

The Element ID field 330 identifies the IDC Capability element 325 within the management frame 320. The Length field 335 specifies the total size of the element 325. The Min Availability Time field 340 defines the minimum availability time required by AP/STA 310, and the Max Unavailability Time field 345 defines the maximum unavailability time the STA 305 can request. These values may be expressed in milliseconds (ms), Time Units (TUs), or a power-of-two scaling factor, with encoding sizes of 4, 6, or 8 bits; or via the encoding such as mantissa-plus-exponent representation or lookup table indexing.

The IDC Resources field may include one or more subfields, including a subfield specifying the maximum rate at which an associated STA is permitted to send to IDC unavailability window messages to its AP. The rate might be expressed as the number of messages per Beacon Interval, per second, or per another time interval. The rate field may be encoded using 2, 4, 6, 8 bits, with fewer bits used for shorter interval (such as a Beacon Interval) and more bits used for longer time (such as per second). Other encoding schemes may also be used, such as a lookup table encoding or a mantissa-plus-exponent encoding.

For dynamic resource indicators, the IDC Capability element 325 includes the IDC Resources field 350, which provides information about the AP's 310 ability to accommodate additional IDC-related operations. One or more subfields of this field 350 may indicate the number of extra P2P TWT requests the AP can support, the number of additional unavailability windows per second or per other unit (e.g., Beacon Interval) it can allow, or the number of extra availability windows per second or per other unit (e.g., Beacon Interval) it can accommodate. The subfields of the Remaining IDC Resources field may be encoded using 1, 2, 4, 6, 8, 12, or 16 bits, depending on the level of granularity required for resource tracking. The depicted IDC Capability element 325 enables the AP/STA 310 to efficiently signal its IDC handling constraints, so that the STAs 305 can make informed decisions when requesting unavailability windows for IDC operations.

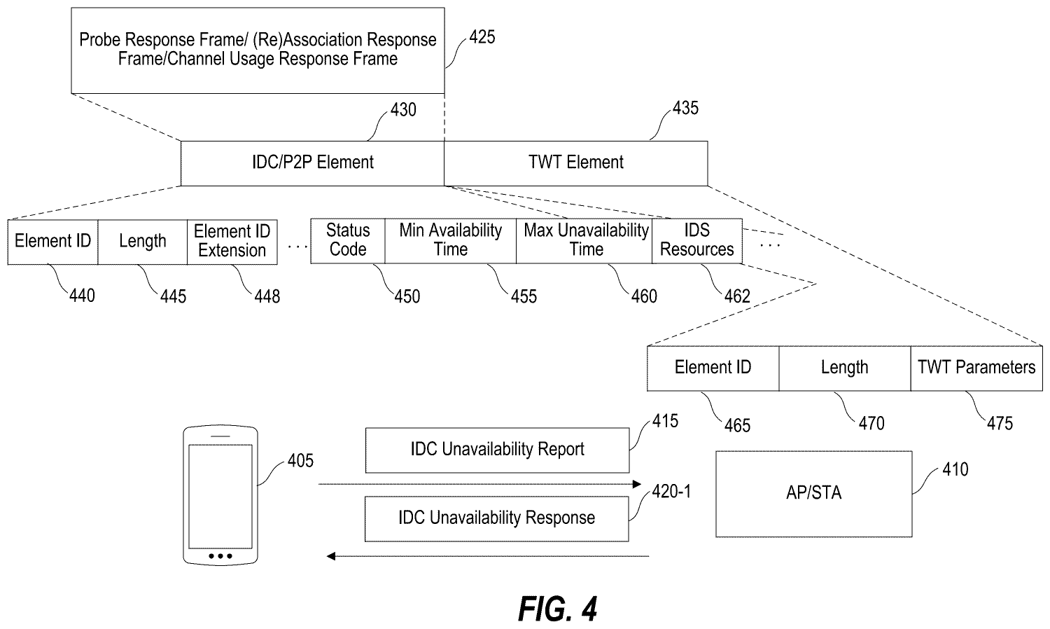

FIG. 4 depicts an example IDC unavailability response 420-1 indicating success, rejection, or modification of requested unavailability windows, according to some embodiments of the present disclosure.

As depicted, STA 405 (which may correspond to STA 105-1 of FIG. 1 or STA 205 of FIG. 2) transmits an IDC unavailability report 415 to associated AP (or peer STA) 410 (which may correspond to AP 110 of FIG. 1, STA 105-2 of FIG. 1, or AP/STA 210 of FIG. 2). The report 415 informs AP/STA 410 of one or more requested unavailability windows. The report 415 may include an individual window, a list of multiple windows, a periodic train of windows, or the start of an IDC (e.g., a DUO session) that allows ongoing window reporting over time. The report 415 may be sent using a (Re) Association Request frame, an OMN frame, a Channel Usage Request frame, or another suitable management frame. Upon receiving the report, AP/STA 410 evaluates the requested window(s). For each window, whether individual, part of a list, or part of a periodic train, parameters such as the requested window's start time (e.g., T1), duration (e.g., 0.5 ms or 2 TUs), or end time (e.g., T2) are considered. The AP compares these with predefined AP's 410 IDC handling constraints (e.g., the minimum availability time, the maximum unavailability time, and the remaining resources). For individual or list-based reports, AP/STA 410 may evaluate whether the static or dynamic rate limits (e.g., max number of unavailability windows per second or per Beacon Interval) are exceeded. For periodic train-based windows, the AP may check whether the duration of each window is too long, whether the gap between windows (e.g., end of one and start of the next) is too short, or whether the overall rate of windows is acceptable under current conditions. In session-based reporting, such as a DUO session, the AP may additionally access whether it is already managing too many active IDC sessions and whether it has sufficient capacity to accept and track a new one. Based on this evaluation, AP/STA 410 determines how to handle the reported unavailability windows. In some embodiments, for a single window or a list of windows, the AP may choose to honor the request silently, adjusting its scheduling as needed without sending an explicit response. If the request cannot be accommodated, the AP may simply ignore the window, and the STA will infer that the window was not honored, either through ongoing performance behavior or based on coordination rules (e.g., failed data exchange). For requests involving a periodic train of windows (e.g., P2P TWT coordination) or session-based reporting (e.g., DUO sessions that enable ongoing or multi-window reporting), the AP is more likely to send a formal response 420-1 (also referred to in some embodiments as IDC service response) that either accept or reject the proposed windows. If the requested parameters cannot be accepted, in some embodiments, the AP may issue a rejection with a counterproposal, suggesting alternative parameters such as a shorter requested unavailability time, a longer requested availability time, or a reduced repetition rate. This allows the STA to adjust its request to better align with the AP's scheduling capacity and network conditions.

Once a decision is made, AP/STA 410 transmits the IDC unavailability response 420-1 (also referred to in some embodiments as IDC service response) to the requesting STA 405. The response 420-1 may be sent using a (Re) Association Response frame, an OMN frame, a Channel Usage Response frame, or another suitable format. The decision may be conveyed using a field such as a status code, which may be included directly in the frame or within an existing element, such as the Ultra-High Reliability (UHR) element, or in a newly defined element, such as the IDC/P2P element 430 as depicted.

As illustrated, the IDC/P2P element 430 includes multiple fields: an Element ID field 440, a Length field 445, an Element ID Extension field 448 (included if Element ID=255), and a Status Code field 450. One or more of the fields after the Length field 545 may be present. The Element ID field 440 identifies the IDC/P2P element 430 within the management frame 425. The Length field 445 specifies the total sides of the IDC/P2P element 430. The Status Code field 450 indicates the decision made by the AP/STA 410 regarding the requested unavailability window. When the requested unavailability window is approved, the Status Code field 450 includes the code “SUCCESS” or other similar indication. When the request is rejected outright without modification, the Status Code field 450 includes the code “REJECTED” or other similar indication When the request is rejected but with modifications, the Status Code field 450 includes the code “REJECTED_WITH_COUNTERPROPOSAL” or other similar indication. Additionally, in embodiments where the IDC unavailability request is rejected with modification, the IDC/P2P element 430 may include additional fields, such as Min Availability Time field 455, Max Unavailability Time field 460, and IDC Resources field 462. The Min Availability Time field 455 provides a new counterproposed minimum availability time, while the Max Unavailability Time field 460 provides a counterproposed maximum unavailability time. The IDS Resources field 462 includes the capacity constraints of AP/STA 410. This field may encode values such as the maximum unavailability time that AP/STA 410 can be accommodated, the minimum availability time required, and the remaining capacity to support IDC-related requests (e.g., the number of additional P2P TWT sessions, unavailability windows per second, or availability windows per second). One or more of the fields after the IDS Resources field 462 may be present.

In embodiments where a P2P TWT request is received, the response 420-1 may further include counterproposed P2P TWT parameters. These counterproposed P2P TWT parameters may be sent within a TWT element 435, which includes an Element ID field 465 (specifying the element type), a Length field 470 (indicating the size of the element), and a TWT Parameter Field 475 (containing the counterproposed TWT parameters).

The depicted IDC unavailability response 420-1 enables the AP/STA 410 to communicate acceptance, rejection, or necessary modifications before approval is possible to the requesting STA 405. This structure approach allows flexible IDC coordination by enabling negotiated scheduling adjustments.

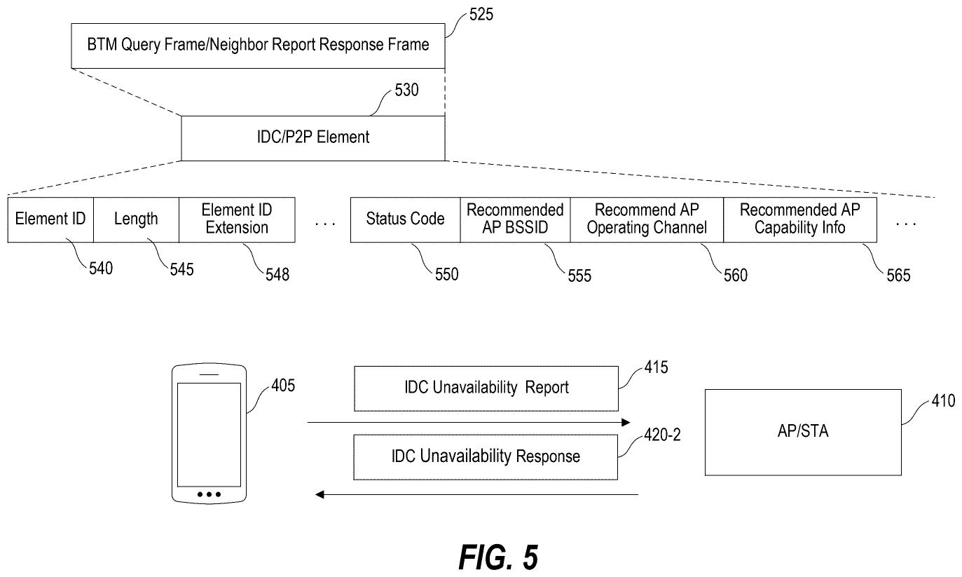

FIG. 5 depicts an example IDC unavailability response 420-2 with alternative AP recommendations, according to some embodiments of the present disclosure.

In some embodiments, when receiving a requested unavailability window from STA 405, AP/STA 410 may determine that it cannot accommodate the request within its constraints. Instead of outright rejecting the request or modifying it, AP/STA 410 may itself reject the request but also recommend an alternative AP if the network environment has other available APs that can better support the requested unavailability window. In such configurations, AP/STA 410 may transmit a response 420-2 (also referred to in some embodiments as IDC service response) that includes information about the alternative AP, suggesting that STA 205 should connect to this AP for scheduling coordination to fulfill its IDC requirements.

The IDC unavailability response 420-2 with alternative AP recommendation may be sent using a Basic Service Set (BSS) Transition Management (BTM) Request frame, a Neighbor Report Response frame, or another suitable management frame. Within these frames, a status code “REJECTED_WITH_ALTERNATIVE_AP” may be included within an existing element, such as an UHR element, or a new element, such as the IDC/P2P element 530 as depicted. The element 530 indicates that the original AP cannot support the request but has provided an alternative solution.

As depicted in FIG. 5, the IDC/P2P element 530 in the response 420-2 includes the following fields: an Element ID field 540, a Length field 545, an Element ID Extension field 548 (included if Element ID=255), a Status Code field 550, a Recommended AP BSSID field 555, a Recommended AP Operating Channel field 560, and a Recommended AP Capability Information field 565. One or more of the fields after the Length field 545 and the Recommended AP Capability Info 565 field may be present. The Element ID field 540 identifies the IDC/P2P element 530 within the frame 525. The Length ID field 545 indicates the total size of the element 530. The Status Code field 550 indicates the rejection with an alternative AP recommendation (e.g., “REJECTED_WITH_ALTERNATIVE_AP”). The Recommended AP BSSID field 555 specifies the Basic Service Set Identifier (BSSID) of the recommended AP. The Recommended AP Operating Channel field 560 indicates the channel on which the recommended AP operates (e.g., operating class and channel number, thereby indicating say channel 36 in a 5 GHz operating class). The Recommended AP Capability Information field 565, if present, may provide additional details about the recommended AP, such as its support for specific IDC coordination, scheduling capabilities for a train of periodic unavailability windows or P2P TWT, or power-saving features.

In some embodiments, when AP 410 determines that it cannot accommodate the requested unavailability window from STA 405, it may transmit a first response 420-1 (e.g., a (Re) Association Response frame or a Channel Usage Response frame) to reject the request outright by including a status code “REJECTED” or other similar indication. Following this rejection, the AP 410 may send a second response 420-2 (e.g., a BTM query or a Neighbor Report Response frame) that includes information about an alternative recommended AP that may better accommodate the requested unavailability window.

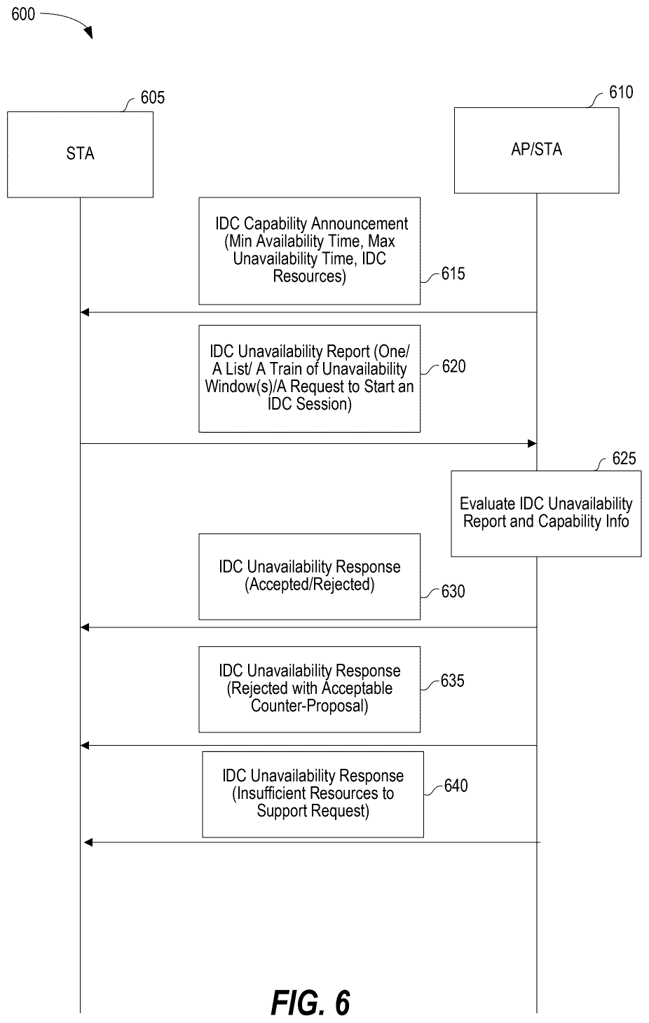

FIG. 6 depicts an example sequence of interactions 600 between a STA 605 and an AP or peer STA 610 for IDC capability announcement and unavailability report handing, according to some embodiments of the present disclosure.

As depicted, AP (or peer STA) 610 (which may correspond to AP 110 or STA 105-2 of FIG. 1 or AP/STA 210 of FIG. 2) transmits an IDC capability announcement 615 (as depicted in FIG. 3) to STA 605 (which may correspond to STA 105-1 of FIG. 1 or STA 205 of FIG. 2). The announcement 615 provides IDC handing constraints, including static constraints like minimum availability time, maximum unavailability time, maximum rate of unavailability window requests, and/or dynamic resource indicators like the number of extra P2P TWT requests, unavailability windows, or availability windows that the AP/STA 610 can support.

Following that, the STA 605 transmits an IDC unavailability report 620 to AP/STA 610, indicating one or more requested unavailability windows. In some embodiments, the report 620 may include a single unavailability windows, defined by a start time (e.g., T1) and either an end time (e.g., T2) or a duration (e.g., 0.5 ms or 2 TUs). In some embodiments, the report 620 may include a list of multiple windows, each with its own start time and duration or end time. In some embodiments, the report 620 may define a train of recurring windows, where the windows follow a specified start time, fixed duration, and a repeat interval, optionally with a defined end time or repeat count. In some embodiments, the report 620 may signal the start of an IDC session, such as a DUO session, that allows the STA to issue follow-up window updates over time using any of the above formats.

Upon receiving the report 620, the AP/STA 610 evaluates the reported unavailability information (as depicted by 625), considering parameters such as the duration of each window, the spacing between adjacent windows, the rate of requests, and whether any session-based limits (e.g., minimum availability time, maximum unavailability time, remaining resources) have been exceeded. These parameters are compared against the IDC handling constraints previously communicated in the capability announcement 615.

Once a decision is made, AP/STA 610 transmits an IDC unavailability response 630 (as depicted in FIG. 4) (also referred to in some embodiments as IDC service response) to STA 605, either accepting, rejecting, or rejecting with a counterproposal. The response may include a status code such as “SUCCESS” (indicating the request is accepted), “REJECTED” (indicating outright rejection), or “REJECTED_WITH_COUNTERPROPOSAL” (indicating rejection but with an acceptable counterproposal, such as a reduced duration or rate). The response may also include revised parameters such as a new minimum availability time or maximum unavailability time.

After the negotiation is complete (e.g., after STA 605 receives the IDC unavailability response 635), the STA 605 and AP 610 proceed to communicate in accordance with the agreed-upon parameters. This may involve, on the AP/STA 610 side, adjusting traffic scheduling and channel access behavior to avoid transmitting to STA 605 during the negotiated unavailability windows, and coordinating transmissions during the agreed available periods in accordance with the negotiated IDC mitigation constraints. On the client side, STA 605 may adapt its behavior to reflect the negotiated parameters. In some embodiments, STA 605 may enforce static compliance, such as spacing out unavailability windows, limiting the duration of each window, and not exceeding the agreed-upon rate of unavailability requests. In dynamic conditions, STA 605 may further ensure that it does not request more unavailability windows per second than permitted, and, in embodiments involving P2P TWT agreements, avoids sending additional TWT requests if the AP 610 has indicated that no further capability is available. In some embodiments, instead of rejecting or suggesting a counterproposal for the request, the AP/STA 610 may recommend an alternative AP to STA 605 (as depicted in FIG. 5). In this configuration, AP/STA 610 may transmit an IDC unavailability response 635 (also referred to in some embodiments as IDC service response) that includes a recommended alternative AP, allowing STA 605 to reassociate with an AP that is better configured to accommodate its IDC scheduling needs. The response may include a status code such as “REJECTED_WITH_ALTERNATIVE_AP”, and includes fields such as the recommended AP's BSSID, operating channel, and IDC capability information.

In some embodiments, one of the IDC unavailability responses 630 (as depicted in FIG. 4) and the IDC unavailability response 635 (as depicted in FIG. 5) is selected for transmission. In embodiments where AP 610 determines that the requested unavailability window cannot be accommodated, the AP 610 may first transmit an IDC unavailability response 630 (as shown in FIG. 4) with an outright rejection using a status code like “REJECTED” or may afterwards transmit an IDC unavailability response 630 (as shown in FIG. 4) with a status code like “NOT HONORED”, and then follow up with a second response 635 (as shown in FIG. 5) that provides information about an updated policy (via static or dynamic parameters) or an alternative AP for reassociation. The two-step approach allows the STA 605 to first understand the rejection before receiving guidance on an updated policy or reassociating with a more suitable AP.

In embodiments where the report 620 includes a single window, and possibly even a list of unavailability windows, AP/STA 610 may choose not to send an explicit response (630 or 635). Instead, in one embodiment, AP/STA 610 may simply not honor the request, based on current capacity or policy. In another embodiment, the AP/STA 610 may transmit an IDC failure notification 640 to STA 605. The response 640 may indicate that there were insufficient resources to support the earlier request 620. Upon receiving the notification, STA 605 may revise and resend an updated IDC unavailability report at a later time. For requests involving a train of periodic unavailability windows or a DUO session initiation, an explicit response (e.g., 630 or 635) may be used, and may include negotiation or counterproposal.

In some embodiments, if the AP or peer STA detects that STA 605 repeatedly request unavailability windows that violates one or more of the previously announced IDC handling constraints (e.g., exceeding a defined threshold), the AP/STA may take enforcement actions. These actions may include transmitting an OMN frame to indicate a reduced service level (e.g., reduced bandwidth or downgraded MCS), issuing a BTM request frame to suggest roaming to an alternative AP, or ultimately sending a Deauthentication frame or Disassociation frame to terminate the connection if the policy violation persists.

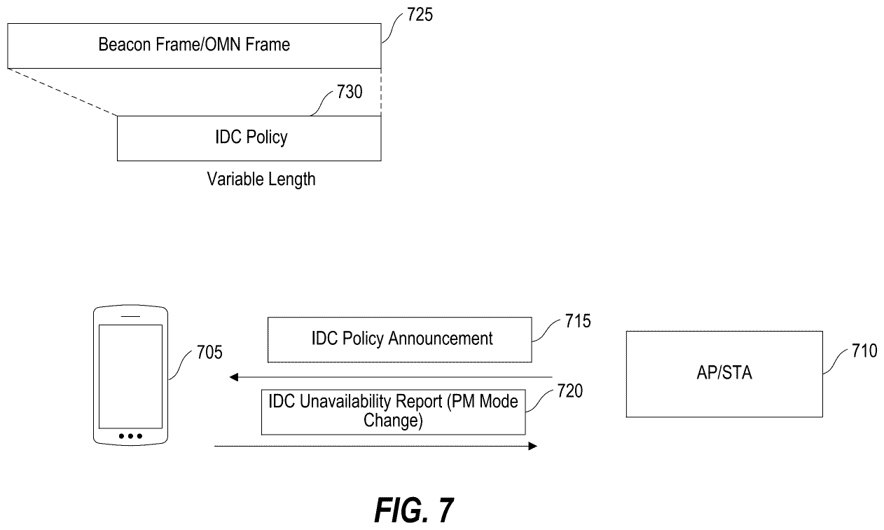

FIG. 7 depicts an example IDC policy announcement 715, indicating the IDC management device's policies related to unavailability reporting via a PM mode change, according to some embodiments of the present disclosure.

As depicted, STA 705 (which may correspond to STA 105-1 of FIG. 1 or STA 205 of FIG. 2) participates in a workflow where IDC unavailability is reported through a change in the PM bit. A transition to PM=1 signals that the STA 705 intends to enter a low-power state, and PM=1 signals a return to active operation. The use of the PM bit to communicate unavailability is assumed within this workflow and forms the basis of the subsequent policy coordination.

Prior to receiving any PM-mode-based reports, AP/STA 710 (which may correspond to AP 110 of FIG. 1 or AP/STA 210 of FIG. 2) transmits an IDC policy announcement 715 to STA 705. The announcement 715 may be carried in a Beacon frame, an OMN frame, or another suitable management frame. The announcement 714 includes constraints and operational rules governing how the AP or peer STA 710 intends to interpret and enforce IDC coordination via PM-mode changes.

In some embodiments, the policy announcement 715 may include static constraints, such as the minimum duration for which a STA is expected to remain in active mode (PM=0), or the minimum time the STA remains awake (e.g., PM=1 after sending a PS-Poll). The announcement 715 may also indicate a maximum rate at which PM model transitions are allowed over a given time interval. In addition, the policy announcement 715 may also include dynamic conditions, such as the remaining internal capacity of the AP to support ongoing PM-mode changes from multiple clients. These static and dynamic policies are collectively conveyed in an IDC Policy field 730. In some embodiments, the IDC Policy field 730 may be encoded using variable-length or multi-bit fields to indicate support for IDC unavailability reporting using scheduled PM bit changes, and to convey one or more IDC handling constraints (e.g., allowable unavailability durations, reporting rates, minimum availability intervals, or remaining resource capacity for processing IDC-related requests).

Upon receiving the IDC policy announcement 715, STA 705 proceeds to transmit an IDC unavailability report 720 back to AP/STA 710. The report 720 may include a PM mode change indicating its intent to enter an unavailable state. As used herein, the PM mode change serves as an implicit indication of an unavailability window (e.g., compared with an explicit indication of an unavailability window in the Channel Usage Request frame as depicted in FIG. 4), as the STA 705 will not be able to receive or transmit Wi-Fi traffic during this period. This approach enables lower-overhead signaling.

While the method of reporting introduces very little signaling overhead and is compatible with baseline 802.11 behavior, it does not explicitly communicate the expected duration, rate of use, or other parameters that are typically included in more structured IDC signaling (e.g., via Channel Usage Request frame) (as depicted in FIG. 4). As a result, AP/STA 710 monitors PM-mode transitions from STA 705 and assess how often the STA 705 enters or exists low-power mode, how long it remains unavailable, and how frequently availability is restored. If the AP/STA 710 observes that the STA 705 is entering low-power mode too frequently, remaining unavailable for excessive durations, or offering availability intervals that are too short, AP/STA 710 may determine that the STA's 705 behavior exceeds acceptable IDC coordination threshold or violates stated policies. In such configuration, since PM-mode transitions are part of standard 802.11 operation and cannot be explicitly blocked, the AP/STA 710 cannot tear down support for PM-based signaling. Instead, AP/ATA 710 may take enforcement actions, such as transmitting management frames (e.g., OMN) to notify the STA 705 of degraded service conditions, issuing a Basic Service Set (BSS) Transition Management (BTM) Request to prompt the STA 705 to reassociate with a different AP or AP MLD, reducing service levels by limiting channel bandwidth or lowering MCS rates, or ultimately disassociating the STA 705 if the policy violations persist. These actions allow the AP/STA 710 to discourage or penalize non-compliant behavior without violating standard protocol requirements. The AP/STA 710 may therefore preserve fair access and coexistence efficiency across the network.

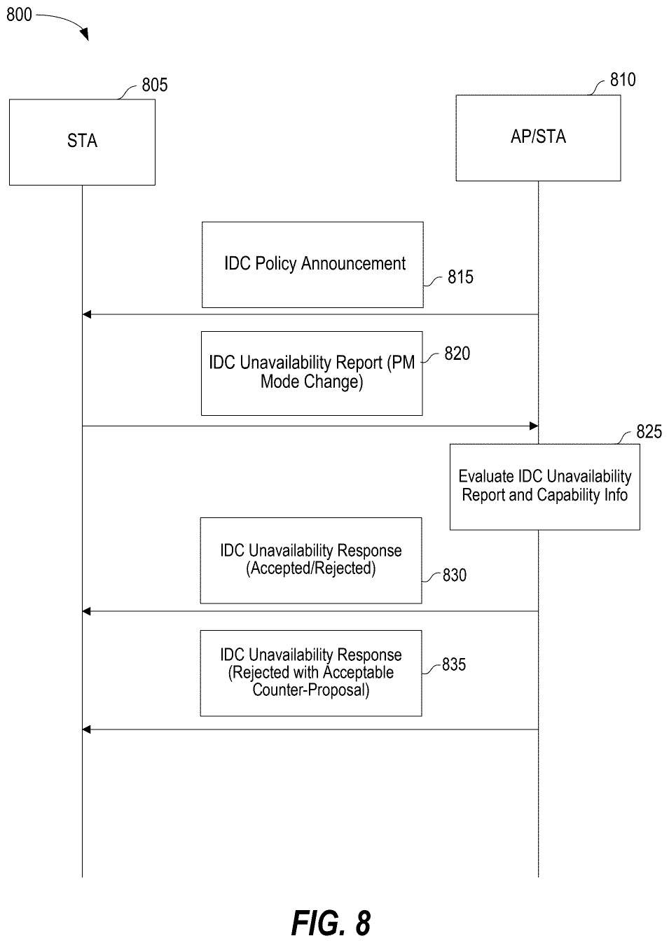

FIG. 8 depicts an example sequence of interactions 800 between a STA 805 and an AP or peer STA 810 for IDC unavailability reporting via a PM mode change, according to some embodiments of the present disclosure.

As depicted, AP (or peer STA) 810 (which may correspond to AP 110 or STA 105-2 of FIG. 1 or AP/STA 210 of FIG. 2) transmits an IDC policy announcement 815 to STA 805 (which may correspond to STA 105-1 of FIG. 1 or STA 205 of FIG. 2). The announcement 815 may be carried in a Beacon frame, OMN frame, or another suitable management frame. The announcement 815 may indicate that it supports IDC unavailability reporting using a scheduled PMM bit mode change, and may further include one or more static and/or dynamic IDC constraints (or policies). These constraints may include the minimum duration of active or awake periods, the maximum allowed rate of PM mode transitions, and the remaining system capacity to honor such changes. These constraints may be encoded within an IDC Policy field, which may support multi-bit fields or variable-length encoding to express thresholds and resource status.

After receiving the announcement 815, STA 705 transmits an IDC unavailability report 820 back to AP/STA 810. The report 820 may be a control frame with a PM mode change (e.g., transitioning from 0 to 1). The PM mode serves as an implicit indication of the start of an unavailability window, during which STA 805 intends to enter aa low-power mode and suspend normal Wi-Fi communication. In response to such a report, as depicted by step 825, AP/STA 810 evaluates whether it can support this unavailability event based on the current policy, recent STA behavior, and internal capacity.

Depending on the evaluation, STA/AP 810 may transmit a response 830 (also referred to in some embodiments as IDC service response) to STA 805, indicating whether the request is accepted or rejected. The response may include a status code such as “ACCEPTED,” “REJECTED,” or “REJECTED_WITH_COUNTERPROPOSAL”. In embodiments where the report is rejected with counterproposal, the response 835 may include additional fields to communicate parameters for the counterproposal, such as a revised minimum availability duration, maximum unavailability duration, or a rate limit for future PM bit change. The information allows the STA 805 to align its future reporting behavior with the AP's resource and policy constraints.

STA 805 may continue to send subsequent IDC unavailability reports 820 by switching PM mode to signal future windows. AP/STA 810 may monitor the frequency, duration, and spacing of reported unavailability periods. If STA 805 sends PM-mode transitions too frequently, or if the STA's 805 active periods become too short, or the unavailability durations too long, AP/STA 810 may determine the STA's 805 behavior is non-compliant with announced policies and may take enforcement actions accordingly.

In some embodiments, AP/STA 810 may respond with a management message to discourage or penalize the excessive STA behavior. For example, the AP/STA 810 may transmit an OMN frame indicating reduced service levels (e.g., downgraded channel bandwidth or MCS), issues a BTM request to suggest that the STA 805 move to a different AP or AP MLD, or ultimately send a Deauthentication or Disassociation frame to terminate the connection if policy violations persist.

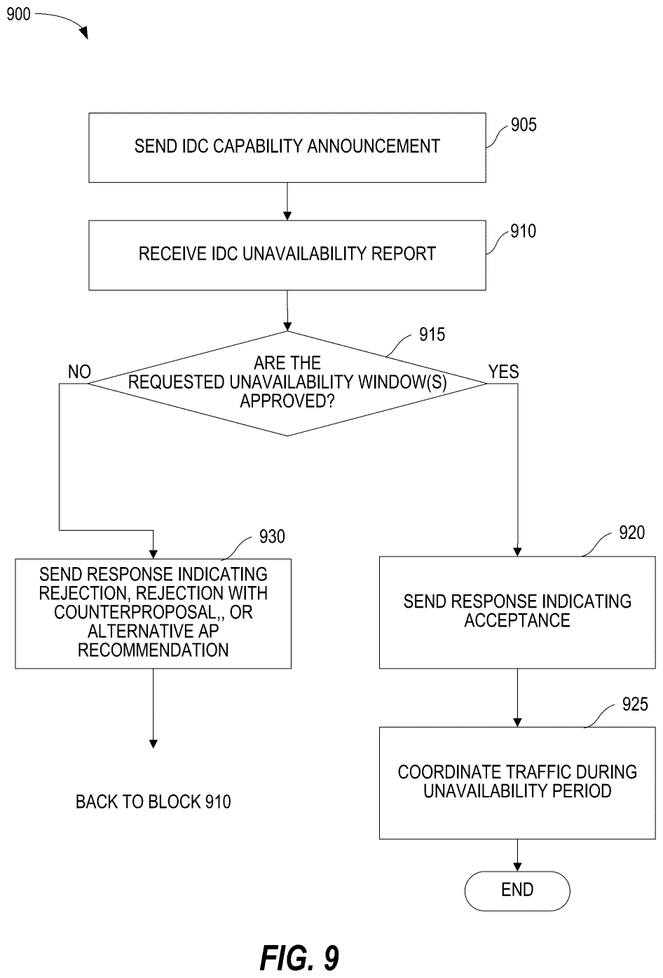

FIG. 9 depicts an example method 900 for an AP or peer STA broadcasting its IDC handling capabilities and evaluating and responding to an IDC unavailability report from an associated STA, according to some embodiments of the present disclosure. In some embodiments, the method 900 may be performed by one or more network devices, such as STA 105-2 or AP 110 as depicted in FIG. 1, AP/STA 210 as depicted in FIG. 2, AP/STA 310 as depicted in FIG. 3, AP/STA 410 as depicted in FIGS. 4-5, AP/STA 610 as depicted in FIG. 6, AP/STA 710 of FIG. 7, and AP/STA 810 of FIG. 8.

At block 905, an AP (or peer STA) (e.g., STA 105-2 or AP 110 of FIG. 1) sends an IDC capability announcement to its associated STAs (e.g., 105-1 of FIG. 1). The announcement (e.g., 315 of FIG. 3) provides information about the AP's IDC handling constraints, including static constraints (e.g., minimum availability time, maximum unavailability time, or rate limits) as well as dynamic resource indicators (e.g., the number of additional P2P TWT requests or unavailability windows the AP/STA can currently support). The announcement may be broadcast proactively (e.g., via a Beacon frame) or sent in response to an STA request (e.g., within a Probe Response frame or (Re) Association Response frame).

At block 910, the AP (or peer STA) receives an IDC unavailability report (e.g., 415 of FIG. 4) from an associated STA. The report may be carried in Channel Usage Request frame, (Re) Association Request frame, OMN frame, or another suitable management frame. The report may include a single unavailability window, a list of unavailability windows, a train of recurring windows (e.g., defined by start time, duration, and interval), or a request to initiate an IDC session (e.g., DUO session) that enables continued coordination through future window updates.

At block 915, the AP (or peer STA) evaluates the requested window information, considering parameters such as window start time, duration, end time, and in embodiment of recurring trains, the interval between windows. The AP also determines whether the request complies with previously broadcasted static and/or dynamic constraints. If the request is approved or determined to be honored, the method 900 proceeds to block 920. If the request cannot be accommodated by the AP, the method 900 moves to block 930.

At block 920, the AP determines that the STA's requested unavailability window is approved or honored. In embodiments where the request includes only a single unavailability window or a list of unavailability windows, the AP may choose to honor or ignore the request, without sending an explicit response. For example, the AP may internally schedule around the requested times or may opt out to honor the windows due to insufficient resources. No immediate feedback is required. In some embodiments, the AP may later send a policy update or failure notification if behavior adjustment is needed.

If the request include a train of periodic unavailability windows or represent a request to start an IDC session, AP may generate an explicit response. As depicted at block 925, when the requests complies with the AP's advertised constraints and available resources, AP sends a response to the STA, indicating that the requested unavailability windows or session are accepted. The response may include a status code such as “ACCEPTED” or a similar indication.

If the requested train of windows or the proposed IDC session exceeds supported constraints (e.g., maximum unavailability duration, minimum availability time, or other rate at which session can be supported), AP determines that it cannot support the request. At block 930, the AP transmits a response rejecting the request, using a status code “REJECTED” or a similar indication.

In some embodiments, instead of issuing a simple rejection, the AP may response with a counterproposal, for example by including a “REJECTED_WITH_COUNTERPROPOSAL” status code along with fields that specify revised timing constraints (e.g., a reduced unavailability duration or increased interval between windows). Upon receiving the counterproposal, the STA may adjust its parameters to align with network policy.

In some embodiments, the AP may respond by recommending an alternative AP that is better suited to handle the IDC coordination request. In such configurations, the response may include a status code “REJECTED_WITH_ALTERNATIVE_AP” or a similar indication, along with information about the recommended AP, such as its BSSID, operating channel, and IDC capability attributes.

Following the approval, at block 935, the AP coordinates traffic to avoid transmitting to STA during the approved unavailability period. The traffic coordination and rescheduling is conducted to ensure that Wi-Fi transmissions do not interfere with the STA's other communications. After the coordination, the method 900 ends, and the AP waits for another IDC unavailability report from the STA, and restarts the process as new IDC reports arrive.

After the AP sends a response with rejection, modification, or an alternative AP recommendation, the method 900 cycles back to block 910, where the AP waits for STA to send another report with updated window information. The iterative process continues until the STA adjusts its request to align with the AP's constraints or to reassociate with a recommended AP.

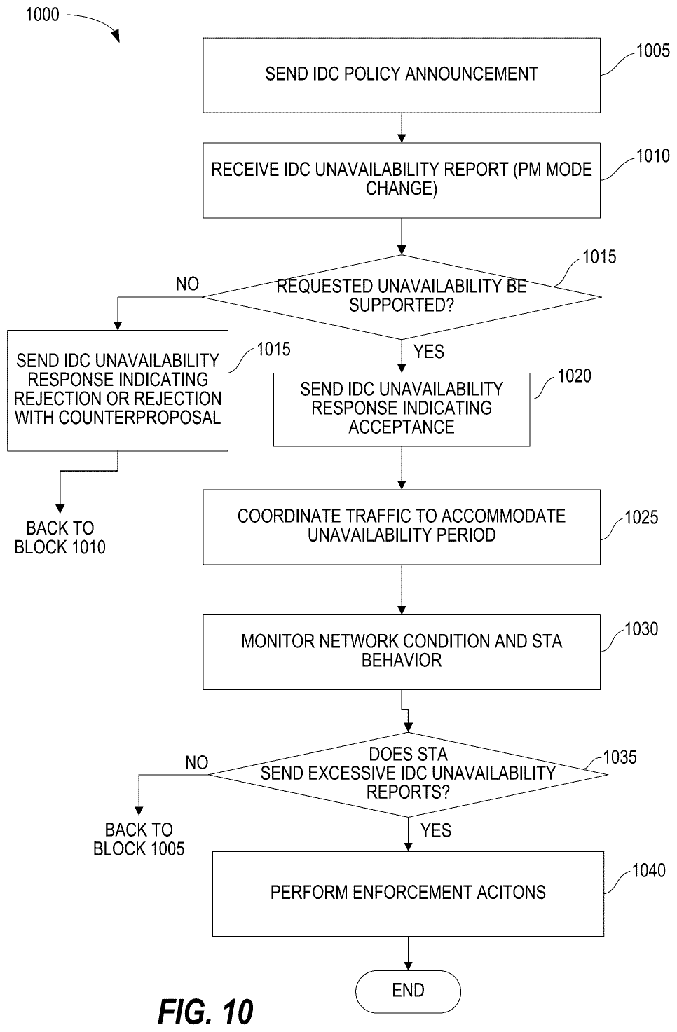

FIG. 10 depicts an example method 1000 for an AP or peer STA handling IDC unavailability reports with PM mode change, according to some embodiments of the present disclosure.

In some embodiments, the method 1000 may be performed by one or more network devices, such as STA 105-2 or AP 110 as depicted in FIG. 1, AP/STA 210 as depicted in FIG. 2, AP/STA 310 as depicted in FIG. 3, AP/STA 410 as depicted in FIGS. 4-5, AP/STA 610 as depicted in FIG. 6, AP/STA 710 of FIG. 7, and AP/STA 810 of FIG. 8.

At block 1005, an AP (or peer STA) (e.g., STA 105-2 or AP 110 of FIG. 1) sends an IDC policy announcement (e.g., 715 of FIG. 7) to a connected STA (e.g., STA 105-1 of FIG. 1). The policy announcement may be carried in a Beacon frame, OMN frame, or other suitable management frame, and include an IDC Policy field (e.g., 730 of FIG. 7) that indicate the AP supports IDC unavailability reporting using a scheduled PM bit mode change (e.g., support=1, not support=0), and may further include one or more static and/or dynamic IDC constraints (e.g., minimum required awake duration, maximum transition rate).

At block 1010, the AP receives an IDC unavailability report (e.g., 720 of FIG. 7) from an associated STA. The report communicates an unavailability window through a PM bit mode change, (e.g., a transition from PM=0 to PM=1), signaling that the STA intends to enter a low-power mode and become unavailability for Wi-Fi communication during the corresponding period.

At block 1015, the AP determines whether the requested unavailability can be supported, based on the static policies and current dynamic resource conditions advertised in the previous announcement (e.g., 715 of FIG. 7). If the request can be supported, the method 1000 moves to block 1020, where the AP sends a response indicating acceptance, for example via an OMN frame or another management message with a corresponding status code. In some embodiments, the AP may choose to skip an explicit response and proceed directly to traffic coordination at block 1020, honoring the request without issuing a formal acknowledgment. If the request exceeds the allowable limits, the method 1000 moves to block 1015, where the AP may transmit a response indicating rejection, or in some embodiments, send a counterproposal specifying modified parameters (e.g., shorter duration, lower frequency) that would be acceptable. These responses may carry a status or reason code and, optionally, include additional fields that describe the modified parameters. The method 1000 then cycles back to block 1010, where the AP receives an updated unavailability report from the STA.

At block 1025, if the requested unavailability is accepted (either as-is or after negotiation), the AP coordinates its transmission schedule to accommodate the STA's reported unavailability period, such as pausing downlink transmissions to the STA during the inferred window to avoid inference or wasted airtime.

At block 1030, the AP monitors ongoing network conditions and STA behaviors, including subsequent PM-mode-based IDC reports. The AP evaluates whether the STA's signaling remains consistent with the previously accepted policy constraints.

At block 1035, the AP determines whether the STA is sending excessive IDC unavailability reports. Excessive behavior may include too frequent PM mode changes, unavailability durations exceeding the maximum supported time, or availability periods that fall below the minimum threshold. If the STA remains within allowed limits, the method loops back to block 1005, where the AP may refresh its IDC policy announcements based on changing network conditions.

If the STA is determined to be non-compliant, the method proceeds to block 1040, where the AP performs enforcement actions to discourage or constrain further problematic signaling. Since PM mode is a built-in feature in 802.11, the AP cannot tear down PM-mode change signaling. Instead, at block 1040, the AP may send an OMN frame to indicate degraded operating parameters (e.g., bandwidth reduced to 20 MHz, reduced buffer thresholds, or downgraded MCS). In some embodiments, the AP may send a BTM request to the STA, suggesting the STA roaming to a different AP or AP MLD. If the STA continues violating policy despite prior indications, the AP may eventually transmit a Disassociation frame or Deauthentication frame to the STA.

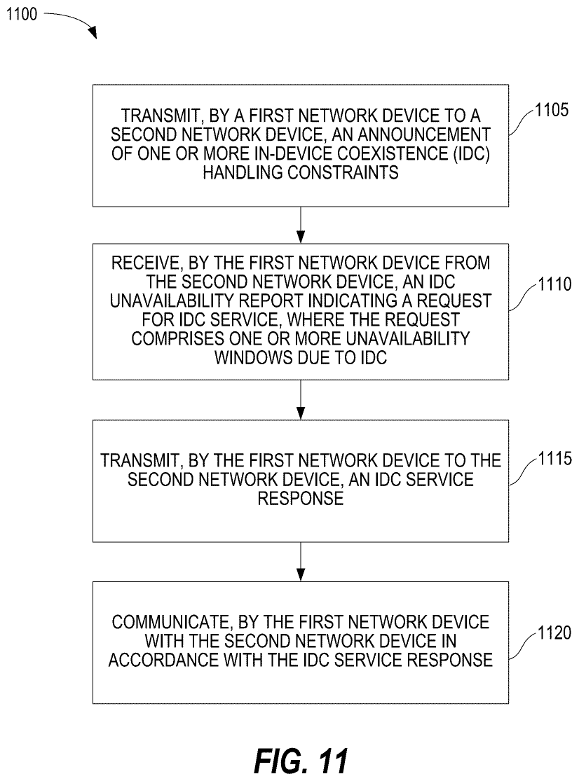

FIG. 11 is a flow diagram depicting an example method 1100 for IDC constraint announcement and unavailability request processing, according to some embodiments of the present disclosure.

At block 1105, a first network device (e.g., AP 110 or STA 105-2 of FIG. 1) transmits an announcement (e.g., 315 of FIG. 3) of one or more in-device coexistence (IDC) handling constraints to a second network device (e.g., 105-1 of FIG. 1). In some embodiments, the one or more IDC handling constraints may comprise at least one of: a minimum availability time, a maximum unavailability time, a maximum rate of reporting unavailability windows, or one or more indications of a remaining resource capacity for handling IDC-related requests, comprising at least one of: a number of peer-to-peer (P2P) target wake time (TWT) requests corresponding to a train of periodically recurring unavailability windows that the first network device is configured to support, or a number of individual unavailability window requests per a time interval that the first network device is configured to support.

At block 1110, the first network device receives, from the second network device, an IDC unavailability report (e.g., 415 of FIG. 4) indicating a request for IDC coordination service, where the request comprises one or more unavailability windows due to IDC. In some embodiments, the IDC unavailability report may comprise at least one of: a single unavailability window, a list of unavailability windows, a train of periodically recurring unavailability windows, or a request to initiate an IDC session for reporting the one or more unavailability windows.

At block 1115, the first network device transmits, to the second network device, an IDC service response. In some embodiments, the IDC service response may comprise at least one of: an approval status code (e.g., “SUCCESS”) indicating an approval of the requested IDC coordination service, a rejection status code (e.g., “REJECTED”) indicating a rejection of the one or more unavailability windows, a modification status code (e.g., “REJECTED_WITH_COUNTERPROPOSAL”) indicating a rejection of the IDC request, and further indicating reception of a future request that comprises at least one of a revised minimum availability or a revised maximum unavailability time, or a recommendation status code (e.g., “REJECTED_WITH_ALTERNATIVE_AP”) indicating a recommendation of a third network device for the second network device to associated to for IDC service.

At block 1120, the first network device communicates with the second network device in accordance with the IDC service response.

In some embodiments, the first network device may comprise a single-link access point (AP) or a multi-link AP.

In some embodiments, the first network device may comprise a single-link station (STA) or a multi-link STA that communicates with the second network device via a peer-to-peer (P2P) connection.

In some embodiments, the second network device may comprise a single-link station (STA) or a multi-link STA.

In some embodiments, the announcement may be transmitted in at least one of a Beacon frame, a Probe Response frame, or a (Re) Association Response frame, and the one or more IDC handling constraints may be included within a least one of an Ultra High Reliability (UHR) Capabilities or Operation element, or an IDC element, or Coexistence (Coex) element.

In some embodiments, any one of the minimum availability time, the maximum unavailability time, or the max rate of reporting unavailability windows may be included within a Static IDC element, a Static IDC subelement, a Static IDC field, or a Static IDS subfield, and any one of the one or more indications of the remaining resource capacity for handling IDC-related requests may be included within a Dynamic IDC element, a Dynamic IDC subelement, a Dynamic IDC field, or a Dynamic IDC subfield.

In some embodiments, the IDC unavailability report indicating the request for IDC service may be received in a Channel Usage Request frame.

In some embodiments, the IDC service response may be transmitted in a Channel Usage Response frame, and the Channel Usage Response frame may comprise a Target Wake Time (TWT) element that comprises at least one of the approval status code, the rejection status code, or the modification status code.

In some embodiments, the TWT element may further comprise one or more parameters for a proposed TWT.

In some embodiments, the IDC service response recommending the third network device may be transmitted in at least one of: a Basic Service Set (BSS) Transition Management (BTM) Request frame, or a Neighbor Report Response frame. The IDC service response may comprise a status code field comprising the recommendation status code, and one or more fields comprising information associated with the third network device.

In some embodiments, the first network device may transmit, to the second network device, a second announcement (e.g., 715 of FIG. 7) indicating that the first network device supports IDC unavailability reporting using a scheduled PM mode change and one or more IDC handling constraints. The first network device may receive, from the second network device, a second IDC unavailability report (e.g., 720 of FIG. 7) comprising a scheduled PM mode change, where the scheduled PM mode change indicates that the second network device is to enter a low-power mode starting at a defined future time or for a defined duration. The first network device coordinate traffic with the second network device to avoid data transmission starting at the defined future time or during the defined duration.

In some embodiments, the second announcement may be transmitted in at least one of a Beacon frame, or an Operation Mode Notification (OMN) frame.

In some embodiments, the first network device may transmit a message for disassociation to the second network device upon determining that the second network device has transmitted IDC unavailability reports using scheduled PM mode change exceeding a defined threshold.

In some embodiments, the first network device may transmit a message for disassociation to the second network device upon determining that the second network device, through the one or more unavailability windows, has violated at least one of the IDC handling constraints indicated in the announcement, where the violation exceeds a defined threshold.

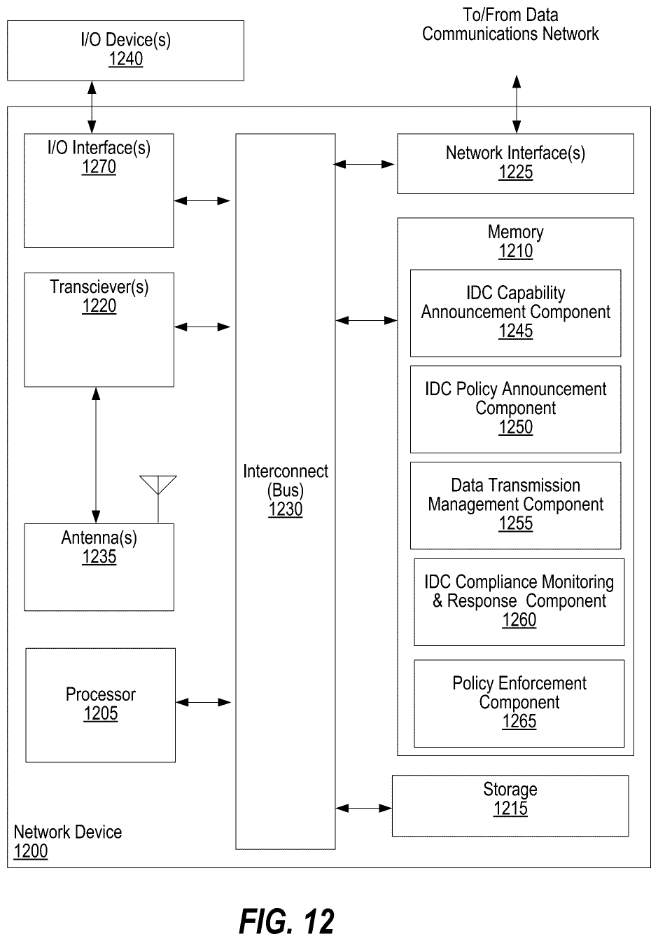

FIG. 12 depicts an example network device 1200 configured to perform various aspects of the present disclosure, according to some aspects of the present disclosure. In some embodiments, the example network device 1200 may be an AP or a STA, and provide IDC mitigation support for an associated STA (e.g., which is a device that operates multiple wireless technologies on shared hardware). In some embodiments, the example network device 1200 may correspond to AP 110 or STA 105-2 as depicted in FIG. 1, AP/STA 210 as depicted in FIG. 2, AP/STA 310 as depicted in FIG. 3, AP/WLC 410 as depicted in FIGS. 4-5, AP/STA 610 as depicted in FIG. 6, AP/STA 710 as depicted in FIG. 7, and/or AP/STA 810 as depicted in FIG. 8.

As illustrated, the example network device 1200 includes a processor 1205, memory 1210, storage 1215, one or more transceivers 1220, one or more I/O interfaces 1280, and one or more network interfaces 1225. In some embodiments, I/O devices 1240 are connected via the I/O interface(s) 1280. Further, via the network interface 1225, the network device 1200 can be communicatively coupled with one or more other devices and components (e.g., via a network, which may include the Internet, local network(s), and the like). Each of the components is communicatively coupled by one or more buses 1230. In some embodiments, one or more antennas 1235 may be coupled to the transceivers 1220 for transmitting and receiving wireless signals.

The processor 1205 is generally representative of a single central processing unit (CPU) and/or graphic processing unit (GPU), multiple CPUs and/or GPUs, a microcontroller, an application-specific integrated circuit (ASIC), or a programmable logic device (PLD), among others. The processor 1205 processes information received through the transceiver 1220, I/O interfaces 1280, and the network interfaces 1225. The processor 1205 retrieves and executes programming instructions stored in memory 1210, as well as stores and retrieves application data residing in storage 1215.

The storage 1215 may be any combination of disk drives, flash-based storage devices, and the like, and may include fixed and/or removable storage devices, such as fixed disk drives, removable memory cards, caches, optical storage, network attached storage (NAS), or storage area networks (SAN). The storage 1215 may store a variety of data for the efficient functioning of the system.

The memory 1210 may include random access memory (RAM) and read-only memory (ROM). The memory 1210 may store processor-executable software code containing instructions that, when executed by the processor 1205, enable the network device 1200 to perform various functions described herein for wireless communication. In the illustrated example, the memory 1210 includes four software components: the IDC capability announcement component 1245, the IDC policy announcement component 1250, the data transmission management component 1255, the IDC compliance monitoring & response component 1260, and the policy enforcement component 1265.

In one embodiment, the IDC capability announcement component 1045 is configured to generate and broadcast the IDC capability announcement (e.g., 315 of FIG. 3) to associated STAs. The announcement may include static constraints (e.g., minimum availability time, maximum unavailability time) and dynamic indicators (e.g., remaining IDC resources). The included information helps STAs to make informed decisions before requesting unavailability windows. The announcement may be proactively broadcast in Beacon frames or sent in response to STA requests via Probe Response frames or (Re) Association Response frames.

When a received IDC unavailability report includes PM mode change, the IDC policy announcement component 1250 may determine whether the network device 1200 supports PM mode-based reporting. The component 1250 may generate and transmit an IDC policy announcement (e.g., 715 of FIG. 7), informing the STA whether PM mode-based reporting is accepted or if explicit IDC request frames are required. The policy announcement may further include one or more static and/or dynamic constraints (e.g., minimum required awake duration, maximum transition rate) for handling IDC-related requests. The policy announcement may be included in a Beacon frame, OMN frame, or another management frame, using an IDC Policy field with variable length.

In one embodiment, the IDC compliance monitoring & response component 1260 evaluates each received IDC unavailability request and compares it with the IDC constraints previously broadcasted in the AP's capability announcement. The IDC compliance monitoring & response component 1260 determines whether to approve, reject, or negotiate modifications to the requested window based on network conditions and resource availability. In PM-mode-based IDC reporting, the IDC compliance monitoring & response component 1260 monitors the frequency and duration of received reports to detect excessive reporting behaviors (e.g., too many unavailability reports in a short time interval).

In one embodiment, the data transmission management component 1255 manages data transmission based on IDC unavailability reports. Once an unavailability window is approved, the data transmission management component 1050 coordinates scheduling and traffic flow to avoid transmitting data to the requesting STA during the approved period. When PM-mode-based IDC reporting is used, the data transmission management component 1050 coordinates traffic upon receiving the report.

In one embodiment, the policy enforcement component 1265 handles enforcement actions when excessive reporting behaviors are detected. When PM-mode-based IDC reporting is used and the reporting behavior is detected as disruptive or excessive, the policy enforcement component 1265 generates and transmits a Deauthentication or Disassociation frame to terminate support for PM-mode-based reporting. After enforcement, the STA may switch to explicit IDC reporting methods for future unavailability reports.

Although depicted as a discrete component for conceptual clarity, in some embodiments, the operations of the depicted components (and others not illustrated) may be combined or distributed across any number of components. Further, although depicted as software residing in memory 1210, in some aspects, the operations of the depicted components (and others not illustrated) may be implemented using hardware, software, or a combination of hardware and software.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A method, comprising:
transmitting, by a first network device to a second network device, an announcement of one or more in-device coexistence (IDC) handling constraints;
receiving, by the first network device from the second network device, an IDC unavailability report indicating a request for IDC service, wherein the request comprises one or more unavailability windows due to IDC;
transmitting, by the first network device to the second network device, an IDC service response; and
communicating, by the first network device with the second network device in accordance with the IDC service response.

2. The method of claim 1, wherein the IDC unavailability report comprises at least one of:
a single unavailability window,
a list of unavailability windows,
a train of periodically recurring unavailability windows, or
a request to initiate an IDC session for reporting the one or more unavailability windows.

3. The method of claim 1, wherein the one or more IDC handling constraints comprises at least one of:
a minimum availability time,
a maximum unavailability time, or
a maximum rate of reporting unavailability windows, or
one or more indications of a remaining resource capacity for handling IDC-related requests, comprising at least one of: a number of peer-to-peer (P2P) target wake time (TWT) requests corresponding to a train of periodically recurring unavailability windows that the first network device is configured to support, or a number of individual unavailability window requests per a time interval that the first network device is configured to support.

4. The method of claim 3, wherein the IDC service response comprises at least one of:
an approval status code indicating an approval of the requested IDC service,
a rejection status code indicating a rejection of the one or more unavailability windows,
a modification status code indicating a rejection of the IDC request, and further indicating reception of a future request that comprises at least one of a revised minimum availability or a revised maximum unavailability time, or
a recommendation status code indicating a recommendation of a third network device for the second network device to be associated to for IDC service.

5. The method of claim 1, wherein the first network device comprises a single-link access point (AP) or a multi-link AP, and the second network device comprises a single-link station (STA) or a multi-link STA.

6. The method of claim 1, wherein the first network device comprises a single-link station (STA) or a multi-link STA that communicates with the second network device via a peer-to-peer (P2P) connection.

7. The method of claim 3, wherein the announcement is transmitted in at least one of a Beacon frame, a Probe Response frame, or a (Re)Association Response frame, and the one or more IDC handling constraints are included within at least one of an Ultra High Reliability (UHR) Capabilities element, UHR Operation element, a Coexistence (Coex) element, or an IDC element.

8. The method of claim 3, wherein any one of the minimum availability time, the maximum unavailability time, or the max rate of reporting unavailability windows are included within a Static IDC element, a Static IDC subelement, a Static IDC field, or a Static IDS subfield, and any one of the one or more indications of the remaining resource capacity for handling IDC-related requests are included within a Dynamic IDC element, a Dynamic IDC subelement, a Dynamic IDC field, or a Dynamic IDC subfield.

9. The method of claim 1, wherein the IDC unavailability report indicating the request for IDC service is received in a Channel Usage Request frame.

10. The method of claim 4, wherein the IDC service response is transmitted in a Channel Usage Response frame, and the Channel Usage Response frame comprises:
a Target Wake Time (TWT) element that comprises at least one of the approval status code, the rejection status code, or the modification status code.

11. The method of claim 10, wherein the TWT element further comprises one or more parameters for a proposed TWT.

12. The method of claim 4, wherein the IDC service response recommending the third network device is transmitted in at least one of:
a Basic Service Set (BSS) Transition Management (BTM) Request frame, or a Neighbor Report Response frame; and
the IDC service response comprises:
a status code field comprising the recommendation status code, and one or more fields comprising information associated with the third network device.

13. The method of claim 1, further comprising:
transmitting, by the first network device to the second network device, a second announcement indicating that the first network device supports IDC unavailability reporting using a scheduled PM mode change and one or more IDC handling constraints;
receiving, by the first network device from the second network device, a second IDC unavailability report comprising a scheduled PM mode change, wherein the scheduled PM mode change indicates that the second network device is to enter a low-power mode starting at a defined future time or for a defined duration; and
coordinating, by the first network device, traffic with the second network device to avoid data transmission starting at the defined future time or during the defined duration.

14. The method of claim 13, wherein the second announcement is transmitted in at least one of:
a Beacon frame, or
an Operation Mode Notification (OMN) frame.

15. The method of claim 14, further comprising:
transmitting, by the first network device, a message for disassociation to the second network device upon determining that the second network device has transmitted IDC unavailability reports using scheduled PM mode change exceeding a defined threshold.

16. The method of claim 3, further comprising:
transmitting, by the first network device, a message for disassociation to the second network device upon determining that the second network device, through the one or more unavailability windows, has violated at least one of the IDC handling constraints indicated in the announcement, wherein the violation exceeds a defined threshold.

17. A system of a first network device, comprising:
one or more computer processors; and
one or more memories collectively containing one or more programs, which, when executed by the one or more computer processors, perform an operation, the operation comprising:
transmitting, by a first network device to a second network device, an announcement of one or more in-device coexistence (IDC) handling constraints;
receiving, by the first network device from the second network device, an IDC unavailability report indicating a request for IDC service, wherein the request comprises one or more unavailability windows due to IDC;
transmitting, by the first network device to the second network device, an IDC service response; and
communicating, by the first network device with the second network device in accordance with the IDC service response.

18. The system of claim 17, wherein the IDC unavailability report comprises at least one of:
a single unavailability window,
a list of unavailability windows,
a train of periodically recurring unavailability windows, or
a request to initiate an IDC session for reporting the one or more unavailability windows.

19. The system of claim 17, wherein the one or more IDC handling constraints comprises at least one of:
a minimum availability time,
a maximum unavailability time, or
a maximum rate of reporting unavailability windows, or
one or more indications of a remaining resource capacity for handling IDC-related requests, comprising at least one of: a number of peer-to-peer (P2P) target wake time (TWT) requests corresponding to a train of periodically recurring unavailability windows that the first network device is configured to support, or a number of individual unavailability window requests per a time interval that the first network device is configured to support.

20. One or more computer-readable media containing, in any combination, computer program code that, when executed by a computer system, performs an operation comprising:
transmitting, by a first network device to a second network device, an announcement of one or more in-device coexistence (IDC) handling constraints;
receiving, by the first network device from the second network device, an IDC unavailability report indicating a request for IDC service, wherein the request comprises one or more unavailability windows due to IDC;
transmitting, by the first network device to the second network device, an IDC service response; and
communicating, by the first network device with the second network device in accordance with the IDC service response.
